(19) United States
(12) Patent Application Publication
(10) Pub. No.: US 2010/0281222 A1
(43) Pub. Date: Nov. 4, 2010

(54) CACHE SYSTEM AND CONTROLLING METHOD THEREOF

(75) Inventors: Kuang-Chih Liu, Hsinchu City (TW); Luen-Ming Shen, Taipei City (TW)

Correspondence Address: J C PATENTS, 4 VENTURE, SUITE 250, IRVINE, CA, 92618, US

(73) Assignee: FARADAY TECHNOLOGY CORP., Hsinchu (TW)

(21) Appl. No.: 12/432,384

(22) Filed: Apr. 29, 2009

(51) Int. Cl. G06F 12/08; G06F 12/00

(52) U.S. Cl. 711/133; 711/143; 711/E12.001; 711/E12.022; 711/E12.026

(57) ABSTRACT

A cache system and a method for controlling the cache system are provided. The cache system includes a plurality of caches, a buffer module, and a migration selector. Each of the caches is accessed by a corresponding processor. Each of the caches includes a plurality of cache sets and each of the cache sets includes a plurality of cache lines. The buffer module is coupled to the caches for receiving and storing data evicted due to conflict miss from a source cache line of a source cache set of a source cache among the caches. The migration selector is coupled to the caches and the buffer module. The migration selector selects, from all the cache sets, a destination cache set of a destination cache among the caches according to a predetermined condition and causing the evicted data to be sent from the buffer module to the destination cache set.

### BACKGROUND OF THE INVENTION

1. Field of the Invention

The present invention relates to a cache system. More particularly, the present invention relates to a cache system fabricated according to a system-on-chip (SoC) multi-processor-core (MPCore) architecture.

2. Description of the Related Art

Please refer to FIG. 1. FIG. 1 is a block diagram showing a conventional cache system of an SoC 100. In the SoC 100, the system bus 108 connects the memory controller 109 and four bus master devices, namely, the direct memory access (DMA) controller 101, the digital signal processor (DSP) 102, and the central processing units (CPUs) 103 and 104. The DSP 102 has a write through cache (WT cache) 105. The CPU 103 has a write back cache (WB cache) 106. The CPU 104 has a WB cache 107.

The bus master devices 101-104, the caches 105-107 and the memory controller 109 are all contained in the SoC 100, while the system memory 120 is an off-chip component. In order to reduce traffic and power consumption, it is preferable to limit operations within the SoC 100, without involving the system memory 120. A write snarfing mechanism is proposed for this purpose.

The WB caches 106 and 107 are capable of supporting the write snarfing mechanism. When a buster master device performs a write operation, the write operation is broadcast on the system bus 108. The WB caches 106 and 107 are notified of the write operation. According to an arbitration algorithm, one of the WB caches 106 and 107 performs the write snarfing and intercepts the write operation accordingly. The data originally intended to be written back to the system memory 120 are written into one of the WB caches instead. Therefore, the write operation is limited within the SoC 100, which reduces traffic and power consumption.

### SUMMARY OF THE INVENTION

Accordingly, the present invention is directed to a cache system and a method for controlling the cache system. The cache system adopts a cache line migration mechanism to reduce traffic, chip area, hardware cost, and power consumption.

According to an embodiment of the present invention, a cache system is provided. The cache system includes a plurality of caches, a buffer module, and a migration selector. Each of the caches is accessed by a corresponding processor. Each of the caches includes a plurality of cache sets and each of the cache sets includes a plurality of cache lines. The buffer module is coupled to the caches for receiving and storing data evicted due to conflict miss from a source cache line of a source cache set of a source cache among the caches. The migration selector is coupled to the caches and the buffer module. The migration selector selects, from all the cache sets, a destination cache set of a destination cache among the caches according to a predetermined condition, and then sends out control signals to cause the evicted data to be sent from the buffer module to the destination cache set.

The cache system and the processors may be fabricated according to a system-on-chip multi-processor-core architecture.

The migration selector may include a plurality of reference counters. Each of the reference counters is corresponding to at least one of the cache sets. The migration selector determines the value of each of the reference counters according to the access frequency of the cache set corresponding to the reference counter.

When anyone of the cache sets is accessed, the migration selector adds one to the value of the reference counter corresponding to the accessed cache set. Moreover, the migration selector subtracts one from the value of each of the reference counter at a predetermined time interval unless the value is equal to a predetermined threshold.

The aforementioned predetermined condition may be selecting a cache set which has at least one empty cache line and is corresponding to the lowest reference counter value among all the values of the reference counters as the destination cache set.

Alternatively, the predetermined condition may be selecting a cache set which has at least one empty cache line and is corresponding to a reference counter value which is lower than the reference counter value corresponding to the source cache set as the destination cache set.

Alternatively, the predetermined condition may be selecting a cache set which has at least one empty cache line and has the largest number of empty cache lines among all the cache sets as the destination cache set.

If more than one cache set is selected according to the predetermined condition, the migration selector may select a selected cache set of the cache with the smallest identification code as the destination cache set. Alternatively, the migration selector may select a selected cache set by random as the destination cache set.

If no cache set is qualified for selection according to the predetermined condition, the buffer module may write the evicted data back to a system memory through a system bus coupled to the buffer module and the system memory.

According to another embodiment of the present invention, a method for controlling the aforementioned cache system is provided. The method includes the following steps. First, receive and store the data evicted due to conflict miss from a source cache line of a source cache set of a source cache among the caches. Next, select, from all the cache sets, a destination cache set of a destination cache among the caches according to a predetermined condition. Next, send the evicted data to the destination cache set.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram showing a conventional cache system.

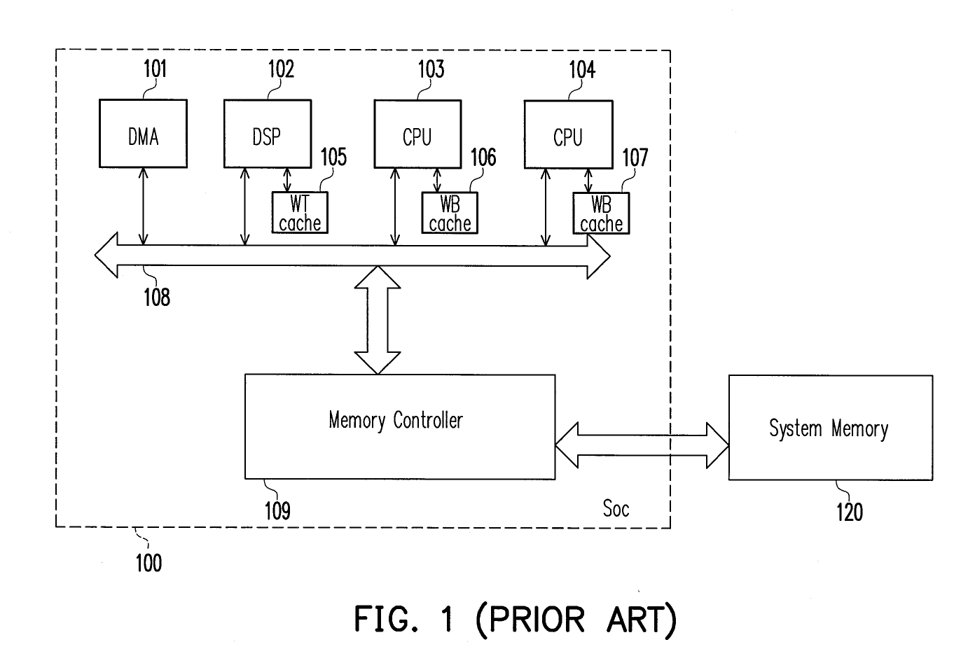

FIG. 2 is a schematic diagram comparing a conventional cache system and another cache system according to an embodiment of the present invention.

FIG. 3 is a block diagram of a cache system according to an embodiment of the present invention.

FIG. 4 is a more detailed block diagram of the cache system in FIG. 3.

FIG. 5 is a flow chart of a method for controlling a cache system according to an embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

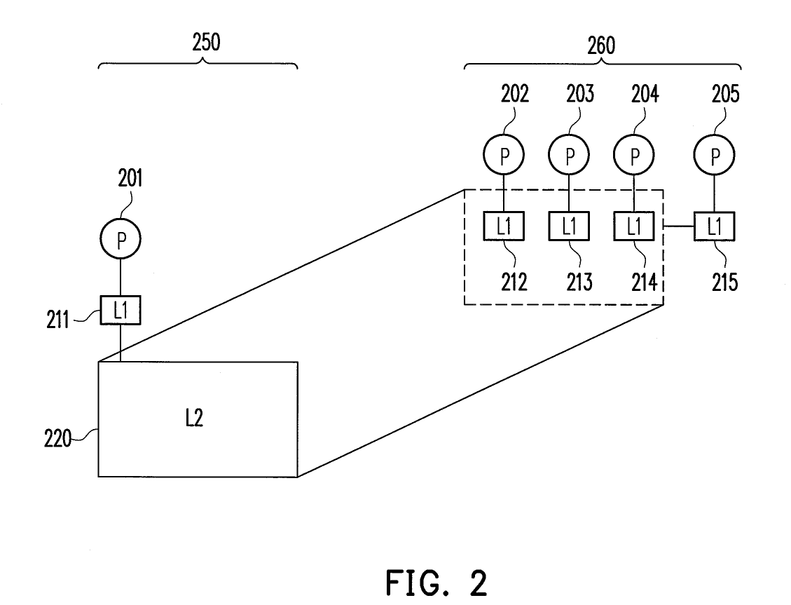

FIG. 2 is a schematic diagram comparing a conventional cache system 250 and another cache system 260 according to an embodiment of the present invention. In the conventional cache system 250, the processor 201 has an L1 cache 211 and an L2 cache 220. The capacity of the L2 cache 220 is larger than that of the L1 cache 211. The processor 201 and the caches 211 and 220 may be fabricated in the same SoC. Alternatively, the L2 cache 220 may be an off-chip component.

In the cache system 260 of this embodiment, each processor 202-205 has a corresponding L1 cache 212-215. When a dirty cache line has to be evicted from an L1 cache, it is probable that another L1 cache has an empty cache line available for storing the evicted data. In this case, the evicted data is migrated to the L1 cache which provides the empty cache line. In this way, each L1 cache 212-215 treats the other three L1 caches as its L2 cache and the real L2 cache can be omitted from the cache system 260. If each L1 cache 212-215 is four-way set associative, the migration mechanism implements a virtual associated set which unites the four L1 caches 212-215 into a sixteen-way set associative cache. The omission of the L2 cache reduces chip area, hardware cost and power consumption. In addition, the migration mechanism in this embodiment is similar to the conventional write snarfing in limiting write operations within the cache system without involving the off-chip system memory, thus effectively reducing traffic and power consumption.

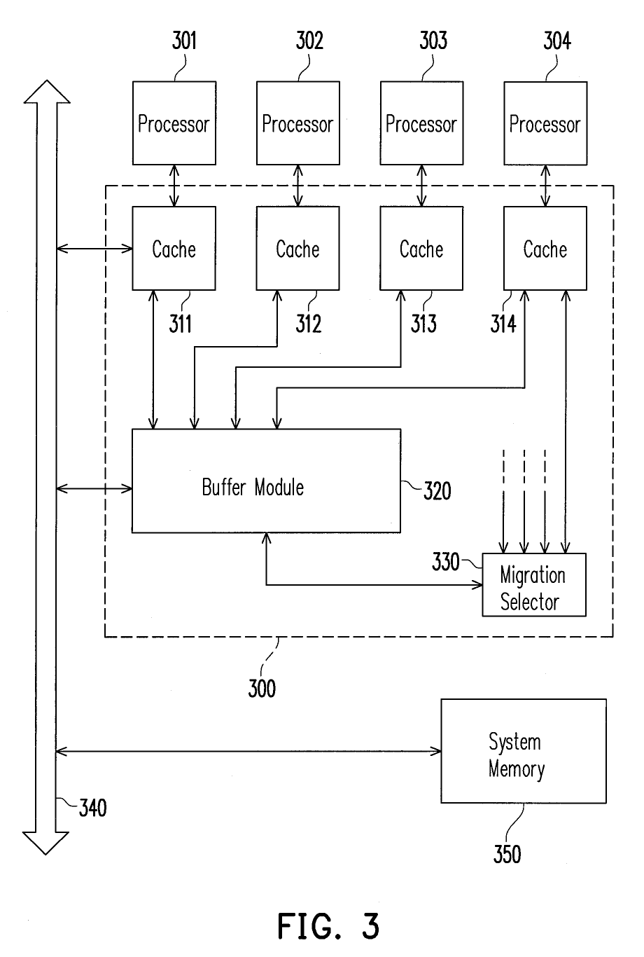

FIG. 3 is a block diagram showing a cache system 300 according to another embodiment of the present invention. The cache system 300 includes the caches 311-314, the buffer module 320, and the migration selector 330. Each of the caches 311-314 is accessed by a corresponding processor 301-304. Each of the caches 311-314 is multi-way set associative. Therefore, each of the caches 311-314 includes a plurality of cache sets and each of the cache sets includes a plurality of cache lines. For example, the size of a cache line may be 16 bytes, 32 bytes, 64 bytes, or other predetermined sizes.

The buffer module 320 is coupled to each of the caches 311-314 for receiving and storing data evicted due to conflict miss from a source cache line of a source cache set of a source cache among the caches 311-314. The migration selector 330 is coupled to each of the caches 311-314 and the buffer module 320. For simplicity, only a part of the coupling between the migration selector 330 and the caches 311-314 is shown in FIG. 3. The migration selector 330 selects, from all the cache sets, a destination cache set of a destination cache among the caches 311-314 according to a predetermined condition, and then sends out control signals to cause the evicted data to be sent from the buffer module 320 to the destination cache set. The cache system 300 and the processors 301-304 may be fabricated according to an SoC MPCore architecture. The system bus 340 is coupled to each of the caches 311-314, the buffer module 320, and the off-chip system memory 350. For simplicity, the coupling between the system bus 340 and the caches 312-314 is not shown in FIG. 3.

In this embodiment, the predetermined condition for selecting the destination cache set is based on the access frequency of each cache set. The migration selector 330 includes a plurality of reference counters. Each of the reference counters is corresponding to one of the cache sets. Alternatively, each reference counter may be corresponding to a predetermined number of the cache sets. The value of each reference counter is determined according to the access frequency of the cache set (or cache sets) corresponding to the reference counter. When a cache set is accessed by the corresponding processor, the migration selector 330 adds one to the value of the reference counter corresponding to the accessed cache set. Besides, the migration selector 330 subtracts one from the value of each reference counter at a predetermined time interval unless the value is equal to a predetermined threshold. For example, the predetermined time interval may be 10 clock cycles and the predetermined threshold may be zero. According to these exemplary numbers, the migration selector 330 subtracts one from each reference counter value every 10 clock cycles. The subtraction of each reference counter value proceeds until the value reaches down to zero. The details of the selection are discussed later.

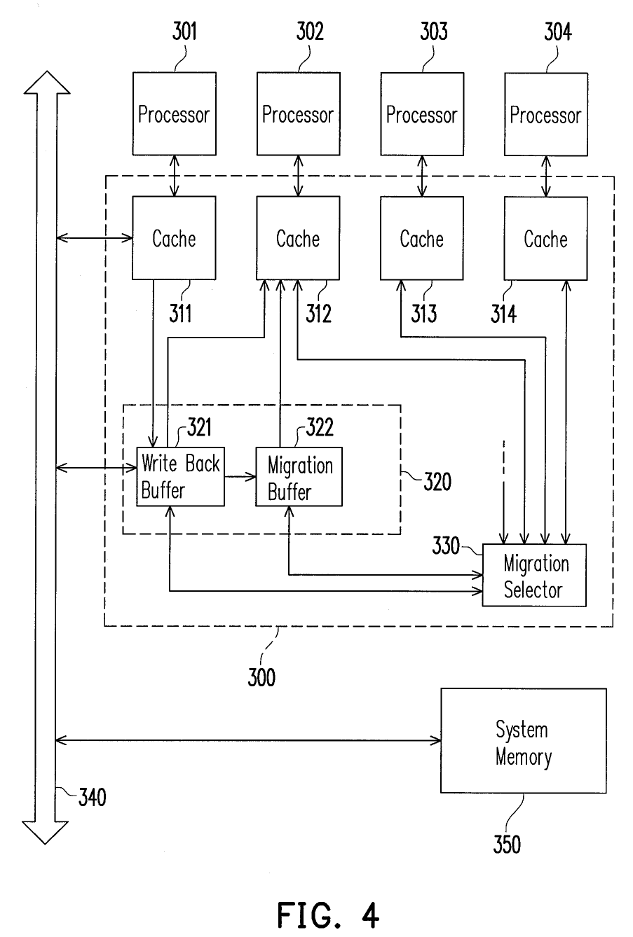

FIG. 4 is a block diagram showing some details of the buffer module 320 in FIG. 3. The buffer module 320 includes four write back buffers and four migration buffers. Each cache 311-314 has a corresponding write back buffer and a corresponding migration buffer. Each of the write back buffers is coupled to the caches 311-314, the migration selector 330, and the system bus 340. Each of the migration buffers is coupled to the corresponding cache, the write back buffers, and the migration selector 330. For simplicity, only the write back buffer 321 corresponding to the cache 311 and the migration buffer 322 corresponding to the cache 312 are shown in FIG. 4. The coupling among the elements is also simplified in FIG. 4.

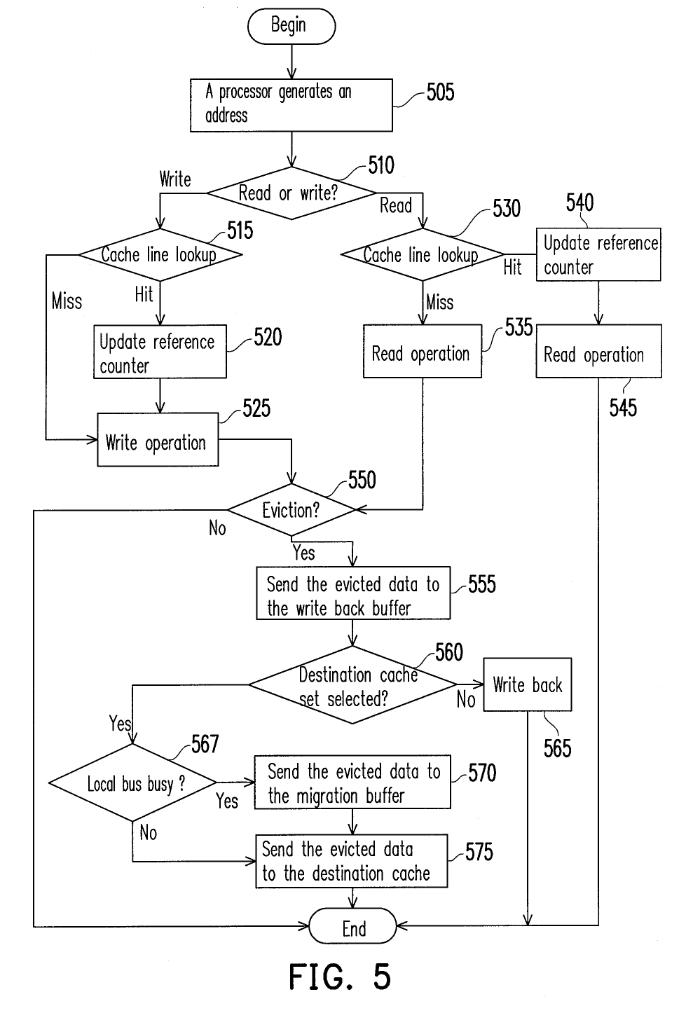

FIG. 5 is a flow chart of a method for controlling the operation of the cache system 300 in FIG. 4. The flow begins at step 505. First, one of the processors 301-304 generates an address of a memory access operation (step 505). For example, it is the processor 301 that generates the address. The read/write type of the memory operation is checked (step 510). If it is a write operation, the flow proceeds to step 515 to look for a cache line matching the address in the cache 311. If there is a cache hit, the migration selector 330 adds one to the value of the reference counter corresponding to the cache set of the cache line (step 520). Next, the write operation is executed (step 525). If the result of the cache line lookup of step 515 is a cache miss, the flow also proceeds to step 525 to execute the write operation. After step 525, the flow proceeds to step 550.

If the result of the type check of step 510 is a read operation, the flow proceeds to step 530 to look for a cache line matching the address in the cache 311. If there is a cache hit, the migration selector 330 adds one to the value of the reference counter corresponding to the cache set of the cache line (step 540). Next, the read operation is executed by simply reading the data of the cache line (step 545).

If the result of the cache line lookup of step 530 is a cache miss, the flow proceeds to step 535 to execute the read operation. Since the data is not stored in the cache 311, the cache 311 attempts to obtain the data from the other caches 312-314. If the data exists in one of the other caches 312-314, the cache 311 receives the data from the one of the other caches 312-314. Data previously migrated to the other caches 312-314 can be retrieved in this way. If none of the other caches 312-314 has the data, the cache 311 gets the data from the system memory 350 through the system bus 340. Such a procedure for obtaining data is conventional in MPCore cache systems and related details are omitted for brevity.

After step 525 or step 535, the flow proceeds to step 550 to check whether eviction happens or not. In case of a cache miss, the data accessed by the memory operation has to be stored into a cache line of the cache 311. If there is already a cache set in the cache 311 matching the address of the memory operation and all cache lines of the cache set contain dirty data, the data of one of the cache lines must be evicted in order to store the data accessed by the memory operation. In this case, the cache line which stores the data to be evicted is the source cache line of the migration. The cache set matching the address of the memory operation is the source cache set of the migration. The cache 311 is the source cache of the migration. The cache 311 sends the evicted data to the write back buffer 321 corresponding to the cache 311 (step 555). The write back buffer 321 receives and stores the evicted data. After the data eviction, the data accessed by the memory operation is stored into the source cache line.

After the write back buffer 321 receives the evicted data, the migration selector 330 begins selecting the destination cache set of the migration according to the predetermined condition (step 560). The predetermined condition may be selecting a cache set which has at least one empty cache line and is corresponding to the lowest reference counter value among all the values of the reference counters as the destination cache set. Alternatively, the predetermined condition may be selecting a cache set which has at least one empty cache line and is corresponding to a reference counter value which is lower than the value of the reference counter corresponding to the source cache set as the destination cache set. Alternatively, the predetermined condition may be selecting a cache set which has at least one empty cache line and has the largest number of empty cache lines among all the cache sets as the destination cache set.

If more than one cache set is selected according to the predetermined condition, the migration selector 330 may select one of the selected cache sets of the cache with the smallest identification code as the destination cache set. Alternatively, the migration selector 330 may select one of the selected cache sets by random as the destination cache set.

If a destination cache set is selected according to the predetermined condition, the cache of the destination cache set is the destination cache of the migration. For example, the destination cache is the cache 312. When the destination cache set is selected by the migration selector 330, the write back buffer 321 checks whether the local bus (different from the system bus 340) leading to the cache 312 is busy (step 567). If the local bus is not busy, the write back buffer 321 sends the evicted data to the cache 312 directly (step 575). The cache 312 receives the evicted data and stores the evicted data in the destination cache line, completing the migration. If the local bus is busy, the write back buffer 321 sends the evicted data to the migration buffer 322 corresponding to the cache 312 (step 570). The migration buffer 322 receives and stores the evicted data. Later, when the local bus is not busy, the migration buffer 322 sends the evicted data to the cache 312 (step 575). The cache 312 receives the evicted data and stores the evicted data in the destination cache line, completing the migration.

If no cache set is qualified for selection according to the predetermined condition (step 560), the write back buffer 321 writes the evicted data back to the system memory 350 through the system bus 340 when the system bus 340 is not busy (step 565).

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A cache system, comprising:
a plurality of caches, wherein each of the caches is accessed by a corresponding processor, each of the caches comprises a plurality of cache sets and each of the cache sets comprises a plurality of cache lines;
a buffer module, coupled to the caches, receiving and storing data evicted due to conflict miss from a source cache line of a source cache set of a source cache among the caches; and
a migration selector, coupled to the caches and the buffer module, selecting from all the cache sets a destination cache set of a destination cache among the caches according to a predetermined condition, and causing the evicted data to be sent from the buffer module to the destination cache set.

2. The cache system of claim 1, wherein the cache system and the processors are fabricated according to a system-on-chip multi-processor-core architecture.

3. The cache system of claim 1, wherein the migration selector comprises a plurality of reference counters, each of the reference counters is corresponding to at least one of the cache sets, and a value of each of the reference counters is determined according to an access frequency of the cache set corresponding to the reference counter.

4. The cache system of claim 3, wherein each of the reference counters is corresponding to a predetermined number of the cache sets.

5. The cache system of claim 3, wherein when one of the cache sets is accessed, the migration selector adds one to the value of the reference counter corresponding to the accessed cache set; the migration selector subtracts one from the value of each of the reference counter at a predetermined time interval unless the value is equal to a predetermined threshold.

6. The cache system of claim 3, wherein the predetermined condition is selecting one of the cache sets which has at least one empty cache line and is corresponding to the lowest value among all the values of the reference counters as the destination cache set.

7. The cache system of claim 3, wherein the predetermined condition is selecting one of the cache sets which has at least one empty cache line and is corresponding to one of the reference counters whose value is lower than the value of the reference counter corresponding to the source cache set as the destination cache set.

8. The cache system of claim 1, wherein the predetermined condition is selecting one of the cache sets which has at least one empty cache line and has a largest number of empty cache lines among all the cache sets as the destination cache set.

9. The cache system of claim 1, wherein if more than one of the cache sets is selected according to the predetermined condition, the migration selector selects one of the selected cache sets of the cache with a smallest identification code as the destination cache set.

10. The cache system of claim 1, wherein if more than one of the cache sets is selected according to the predetermined condition, the migration selector selects one of the selected cache sets by random as the destination cache set.

11. The cache system of claim 1, wherein if no cache set is qualified for selection according to the predetermined condition, the buffer module writes the evicted data back to a system memory through a system bus coupled to the buffer module and the system memory.

12. The cache system of claim 11, wherein the buffer module comprises:
a plurality of write back buffers, each of the write back buffers corresponding to one of the caches and coupled to the caches, the migration selector, and the system bus; and
a plurality of migration buffers, each of the migration buffers corresponding to one of the caches and coupled to the corresponding cache, the write back buffers, and the migration selector; wherein
the write back buffer corresponding to the source cache receives and stores the evicted data from the source cache;
if no cache set is qualified for selection according to the predetermined condition, the write back buffer writes the evicted data back to the system memory through the system bus when the system bus is not busy;
when the destination cache set is selected by the migration selector and a local bus leading to the destination cache is not busy, the write back buffer sends the evicted data to the destination cache;
when the destination cache set is selected by the migration selector and the local bus leading to the destination cache is busy, the write back buffer sends the evicted data to the migration buffer corresponding to the destination cache for storage;
when the migration buffer corresponding to the destination cache stores the evicted data and the local bus is not busy, the migration buffer corresponding to the destination cache sends the evicted data to the destination cache.

13. A method for controlling a cache system, the cache system comprising a plurality of caches each accessed by a corresponding processor, each of the caches comprising a plurality of cache sets and each of the cache sets comprising a plurality of cache lines, the method comprising:
receiving and storing data evicted due to conflict miss from a source cache line of a source cache set of a source cache among the caches;
selecting from all the cache sets a destination cache set of a destination cache among the caches according to a predetermined condition; and
sending the evicted data to the destination cache set.

14. The method of claim 13, further comprising:
providing a plurality of reference counters, wherein each of the reference counters is corresponding to at least one of the cache sets, and
determining a value of each of the reference counters according to an access frequency of the cache set corresponding to the reference counter.

15. The method of claim 14, wherein each of the reference counters is corresponding to a predetermined number of the cache sets.

16. The method of claim 14, further comprising:
when one of the cache sets is accessed, adding one to the value of the reference counter corresponding to the accessed cache set; and
subtracting one from the value of each of the reference counter at a predetermined time interval unless the value is equal to a predetermined threshold.

17. The method of claim 14, wherein the predetermined condition is selecting one of the cache sets which has at least one empty cache line and is corresponding to the lowest value among all the values of the reference counters as the destination cache set.

18. The method of claim 14, wherein the predetermined condition is selecting one of the cache sets which has at least one empty cache line and is corresponding to one of the reference counters whose value is lower than the value of the reference counter corresponding to the source cache set as the destination cache set.

19. The method of claim 13, wherein the predetermined condition is selecting one of the cache sets which has at least one empty cache line and has a largest number of empty cache lines among all the cache sets as the destination cache set.

20. The method of claim 13, further comprising:
if no cache set is qualified for selection according to the predetermined condition, writing the evicted data back to a system memory through a system bus.
